(19) United States
(12) Patent Application Publication
(10) Pub. No.: US 2011/0045250 A1
(43) Pub. Date: Feb. 24, 2011

(54) Extrusion process and product

(76) Inventor: Vic De Zen, Woodbridge (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/805,736

(22) Filed: Aug. 18, 2010

Related U.S. Application Data
(60) Provisional application No. 61/272,138, filed on Aug. 20, 2009.

(51) Int. Cl. B32B 3/30; C08K 11/00; B29C 47/00

(52) U.S. Cl. 428/168; 524/15; 428/167; 264/176.1

(57) ABSTRACT

A thermal insulating and substantially moisture impermeable rigid extrusion comprising 40 to 75 wt % rice husks, a coupling agent, a lubricant, a plasticizer, and the balance a thermoplastic plastic, preferably a thermoplastic polyolefin plastic selected from the group consisting of high density polyethylene, low density polyethylene; linear low density polyethylene, homopolymer polypropylene, copolymer polypropylene, and combinations thereof. The rigid extrusion may be an elongated strip in the shape of a panel, a sheet, a board, a stud, a door frame jamb, a door frame header, an I-beam, a hollow post or beam with partially or fully encapsulated glass fibre reinforcing, a baseboard, a quarter-round, a cove molding, a fascia or a soffit. A preferred rigid extrusion has longitudinal tongue and groove side edges and longitudinal ribs and recesses formed across a face thereof substantially from one side edge to the other. The extrusion may be cut transversely to form a rectangular floor panel having a transverse tongue formed in one end and a mating groove formed in the other end for assembly of abutting panels together side-by-side and end-to-end to produce a continuous floor surface adapted for assembly with the ribbed surface facing downwardly.

### BACKGROUND OF THE INVENTION

(i) Field of the Invention

This invention relates to building products and, more particularly, relates to building products made from recyclable materials which are extrudable into an indefinite length having a variety of shapes and having improved insulating and moisture resistance properties.

(ii) Description of the Related Art

Building products produced from wood typically comprise panels, sheets, boards, planks, trim, door frame jambs and headers, doors and window sash, and the like shaped products which are expensive to produce by shaping methods involving considerable waste.

It is accordingly a principal object of the present invention to provide a composition and an inexpensive and reliable process for producing building products having a desired configuration with little or no waste of starting materials.

It is another object of the present invention to provide an extrudable waterproof composition from waste materials including recyclable thermoplastic polymers, such as polyolefins, and rice husks.

Sub-floors in basements are intended to support, insulate and protect finished flooring lying on the sub-floor from moisture and cold temperatures inherent in concrete substrates.

U.S. Pat. No. 4,918,215 issued Jul. 19, 2005 discloses a floor panel for use in a sub-floor application having an upper member of a sheet floor material and a molded lower member of a waterproof sheet material bonded together, the lower waterproof member having a plurality of projections in the form of knobs to support the panel above, a substrate to protect the upper member from water and allow free drainage of water.

It is a further object of the present invention to provide a waterproof and insulating sub-floor panel of unitary construction produced by a simple process of extruding the composition of the invention into a desired profile of indefinite length.

And another object of the invention is the provision of a novel waterproof sub-floor panel having a ribbed undersurface adopted to lie on a substrate and to permit free moisture drainage.

Building products such as pests, beams, I-beams and engineered beams and trusses for supporting structures typically are produced from wood and from metal such as structural steel and aluminum alloy. Wood must be kept dry or it will rapidly break down due to rot. Structural steel is heavy and is subject to corrosion under humid or wet conditions, necessitating a protective coating such as a paint covering or encapsulation in concrete.

It is a still further object of the present invention to provide a light-weight, dimensionally-stable structural building product reinforced by encapsulated or partially encapsulated glass or graphite reinforced plastic rod, wire or sheet by extruding the composition of the invention while concurrently feeding the reinforcing rod, wire or sheet through the extrusion die.

Exterior decking and fencing conventionally made of wood and pre-treated wood suffer from weathering and UV-radiation and require periodic maintenance by staining or painting.

A still further object of the present invention is the provision of a weather-resistant, UV-resistant and mold-resistant light-weight board produced by coextrusion of the composition of the invention with a capping or by gluing of capping to an extruded board to produce cap stock of a desired cross-sectional configuration.

### SUMMARY OF THE INVENTION

Rice husks produced during the milling of rice comprise almost 25% of the weight of the rice of which about 25% of the weight of the husk contains amorphous silica. Accordingly, every ton of rice produced from a rice mill generates a quarter ton of rice husks normally disposed of as agricultural waste. It has been found that rice husks have a thermal resistance of about R-3 per inch and have good vapour barrier characteristics absorbing only about 10% of their weight in moisture.

I have found that combining finely ground rice husks with particulate or ground thermoplastic polymer plastics, preferably recycled waste thermoplastics, provides a readily extrudable composition of desired shape, for example, a ribbed profile which is particularly suited for use as a sub-floor. The ribbed construction provides excellent support for a finished flooring while permitting flow and drainage of moisture emanating from the typical concrete substrate. A rice husk-polyolefin composition of the sub-floor provides enhanced thermal insulation and vapour barrier while utilizing an agriculture by-product and recycled thermoplastic material.

Building products typically made from wood such as panels, sheets, boards, studs, door frame jambs and headers, door and window casings, doors and window sash, baseboards, quarter-rounds, half-rounds, fascias, soffits and the like can be produced having the tensile strength and rigidity of wood but substantially free of water absorption while providing improving thermal insulation.

I have found that the addition of a light-weight reinforcing rod, wire or sheet of a fiber-reinforced polymer such as glass- or graphite-reinforced plastic to the composition of the invention adds tensile strength and enhanced dimensional stability to the resulting composite product. The reinforcing material can be fed as a stiff and resilient rod, wire or sheet typically made of glass-reinforced polymer such as polyester, vinylester or epoxy. The glass or graphite fiber reinforcement added by way of the rod, wire or sheet imparts high tensile strength to the composite product. The composite product can be produced in desired configurations such as in an elongated hollow box structure or I-beam or angle. The reinforcing rod, wire or sheet can be fully or partially encapsulated by the composition and can be strategically positioned in the composite product to provide optimum tensile strength and to complement the compressive strength of the composition.

Cap stock comprised of an extrusion such as boards comprised of rice husks with a plasticizer and the balance a thermoplastic polymer such as a polyolefin plastic, capped with an adhesive-backed glued-on veneer such as polyvinyl chloride or the like veneer on selected exposed surfaces, or coextruded on a surface or surfaces thereof with vinyl or polyolefin cap stock, provides weather and ultraviolet resistance on visible surfaces while obviating the need for painting or staining. The composition can be mixed with, a blowing agent such as sodium bicarbonate to provide an expanded light-weight cellular extrusion laminated by capping on exposed surfaces, which is particularly suited for use as boards on decks.

The cap stock can be textured and coloured to simulate wood grain to provide a natural wood appearance resistant to cracking, splitting and fading while necessitating low maintenance. Flexible thermoplastic polymers can be co-extruded with rigid thermoplastic polymers to provide cap stock having flexible tabs or wedges along edges to provide vapour and weather seals.

In its broad aspect, an embodiment of thermal insulating and substantially moisture impermeable products of the invention comprises a rigid extrusion consisting of 40 to 75 wt % rice husks, 0.3 to 3 wt % coupling agent 2 to 5 wt % lubricant, and 1 to 5 wt % plasticizer, the balance thermoplastic polymer, said rice husks having a particle size in the range of 20 to 80 U.S. Sieve size and the thermoplastic polyolefin plastic being granular or having a particle size in the range of ⅜ inch to ½ inch. More preferably, a floor panel of the invention consists of 60 to 70 wt % rice husks, 0.5 to 1.5 wt % coupling agent, 2 to 2.5 wt % lubricant, 2 to 3 wt % plasticizer, and the balance the thermoplastic'polymer, preferably a thermoplastic polyolefin.

In a preferred embodiment, the rigid extrusion is a planar strip having a pair of longitudinal side edges and longitudinal ribs and recesses formed across a face thereof substantially from one side edge to the other, a longitudinal tongue formed on one side edge and a mating longitudinal groove formed on the other side edge.

The extrusion is cut transversely to form a floor panel rectangular in shape, preferably square, having a pair of transverse ends, with a transverse tongue formed across the panel in one end continuous with the longitudinal tongue on one side edge and a mating groove formed across the other end continuous with the longitudinal groove on the other side edge for assembly of abutting panels together to produce a continuous floor surface adapted for assembly with the ribbed surface facing downwardly. Preferably, the ribs and recesses formed across a face of the panel are equispaced and have a spacing of from 0.5 to 0.8 inches.

The thermoplastic polymer preferably is a recyclable polyolefin plastic selected from the group having the characteristics of high density polyethylene, low density polyethylene, linear low density polyethylene, homopolymer polypropylene, copolymer polypropylene, or combinations thereof including solid and cellular polyolefins. Other thermoplastic polymer such as thermoplastic PVC, polyurethane and polyester may be selected.

The method of the invention for producing a thermal insulating and moisture impermeable rigid extrusion of the invention comprises mixing a composition comprising 40 to 75 wt % rice husks, 0.3 to 3 wt % coupling agent, 2 to 5 wt % lubricant, 1 to 5 wt % plasticizer, the balance a thermoplastic polymer, and extruding the composition at a temperature in the range of about 300° to 400° F. through a die having a profile for producing a strip having a desired shape, cooling the strip and cutting the strip to a desired length.

In a preferred embodiment, the extrusion is planar and has a pair of opposite longitudinal side edges, one of said side edges having a tongue and the other side edge having a mating groove, and said strip having a planar surface on one side and a longitudinal ribbed surface on the other side. The cooled strip is transversely cut and shaped to produce a rectangular panel having opposite transverse ends with a tongue formed across one end and a mating groove formed across the opposite end. Equispaced transverse recesses or slots can be routed on the ribbed surface perpendicular to the longitudinal ribs to provide a knobbed surface.

Preferably, the mixture consists essentially of 60 to 70 wt % rice husks, 0.5 to 1.5 wt % coupling agent, 2 to 2.5 wt % lubricant such as paraffix wax, 2 to 3 wt % plasticizer, and the balance a thermoplastic polyolefin plastic. The thermoplastic polyolefin plastic is selected from high density polyethylene, law density polyethylene, linear low density polyethylene, homopolymer polypropylene, copolymer polypropylene, or combinations thereof.

### BRIEF DESCRIPTION OF THE DRAWINGS

The composition and product of the invention will now be described with reference to the accompanying drawings, in which:

FIG. 1 is a perspective view of an embodiment of extrusion of the invention transversely cut and shaped into a floor panel;

FIG. 2 is a plan view of the panel shown in FIG. 1;

FIG. 3 is a front elevation view of the panel shown in FIG. 2;

FIG. 4 is a side elevation of the panel shown in FIG. 2;

FIG. 5 is a vertical section taken through line 5-5 of FIG. 2;

FIG. 6 is an enlarged vertical section of a, portion of floor panels of the invention assembled together;

FIG. 7 is a front perspective view of a door frame jamb extrusion of the invention;

FIG. 8 is a transverse section through the jamb of FIG. 7;

FIG. 9 is a perspective view of a baseboard extrusion;

FIG. 10 is a transverse section through the baseboard of FIG. 9;

FIG. 11 is a perspective view of a cove molding extrusion;

FIG. 12 is a transverse section through the cove molding of FIG. 11;

FIG. 13 is a perspective view of a cove extrusion;

FIG. 14 is a transverse section through the cove of FIG. 13;

FIG. 15 is a perspective view of a quarter-round extrusion;

FIG. 16 is a transverse section through the quarter-round of FIG. 15;

FIG. 17 is a perspective view of a half-round extrusion;

FIG. 18 is a transverse section through the half-round of FIG. 17;

FIG. 19 is a perspective view of an I-beam extrusion;

FIG. 20 is a vertical section through the I-beam extrusion of FIG. 18;

FIGS. 21 to 32 illustrate several embodiments of elongated hollow composite structures of the invention having glass reinforced plastic rods, sheets or angles fully or partially encapsulated by the composition of the invention;

FIGS. 33 to 35 are perspective views illustrating embodiments of panel, door and door/window sash structures of the invention;

FIG. 36 is a transverse section view taken along line 36-36 of FIG. 33;

FIGS. 37 and 38 are mirror-image sectional views of the outer frame side members of the embodiments of the invention shown in FIGS. 33 to 35;

FIG. 39 is an enlarged sectional view taken at “B” of FIG. 36;

FIG. 40 is an enlarged sectional view taken at “A” of FIG. 36;

FIG. 41 is a plan view of another embodiment of floor panel of the invention;

FIG. 42 is a side elevation of the plan shown in FIG. 41;

FIG. 43 is a sectional view of an extrusion of the invention having a capping; and

FIG. 44 is a sectional view of cap stock of the invention having a flexible tab or flap.

### DESCRIPTION OF THE PREFERRED EMBODIMENTS

The composition of the invention comprises about 40 to 75 weight %, preferably 60 to 70 weight %, of rice husks, 0.3 to 3 weight %, preferably 0.5 to 1.5 weight %, of a coupling agent, 2 to 5 weight %, preferably 2 to 2.5 weight %, of a lubricant such as paraffin wax, or oxidized polyethylene wax, and 1 to 5 weight %, preferably 2 to 3 weight % of a plasticizer as an impact modifier such as JAYFLEX™ produced by Imperial Oil, the balance a thermoplastic polymer, such as polyolefin plastic, preferably a recycled plastic, comprising about 25 to 50 weight % thermoplastic polyolefin. The thermoplastic polyolefin may have a particle size in the range of ⅜ inch to ½ inch and the rice husks and remaining constituents are ground to a size in the range of 20 to 80 mesh U.S. Sieve Series, i.e. 0.84 min to 0.18 mm. The thermoplastic polyolefin, typically recycled thermoplastic bottles, bubble packages and the like, may be high density polyethylene, low density polyethylene, linear low density polyethylene, homopolymer polypropylene, copolymer polypropylene, or combinations thereof. The ground rice husks, thermoplastic polyolefins, coupling agent, lubricant and plasticizer are blended together, heated to a softening and melting temperature of the thermoplastic polyolefin, typically 300°-400° F., preferably 350°-375° F., and extruded through an extrusion die having the desired product profile. The polyolefin material encapsulates the solid constituents and functions as a continuous matrix phase having the solid constituents uniformly suspended therein as a discrete phase.

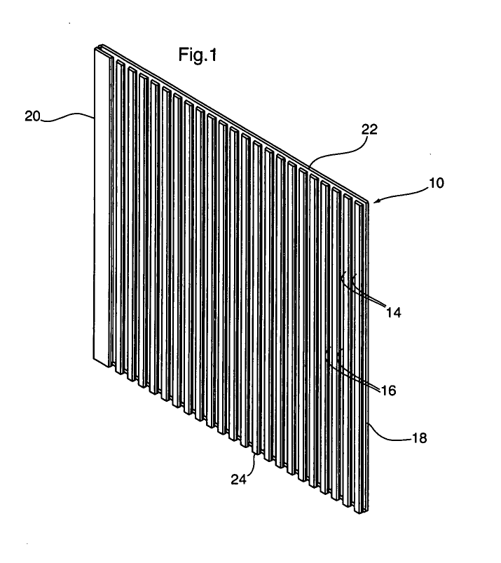

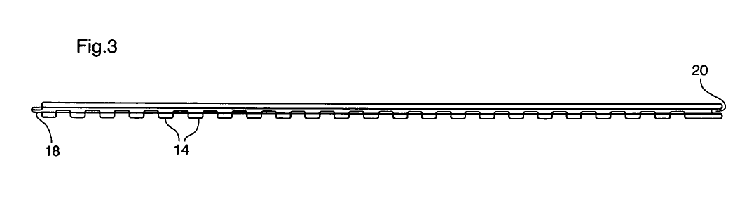

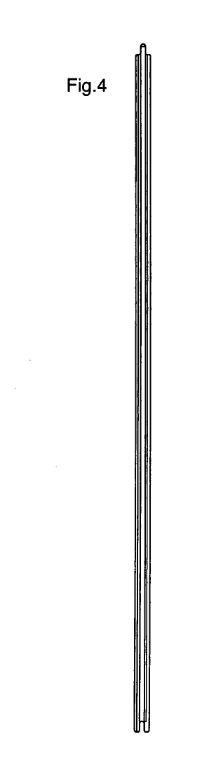

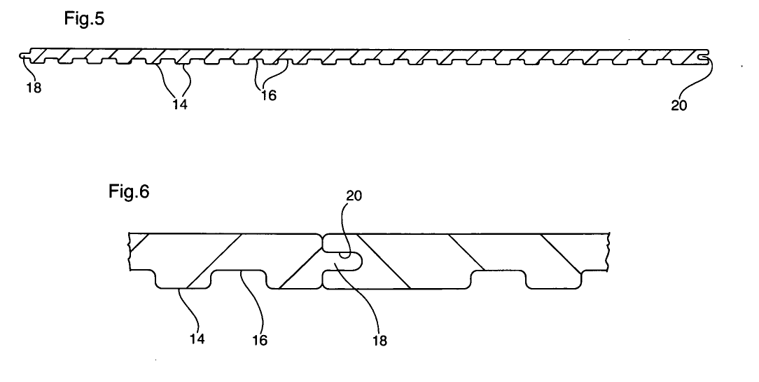

With reference to the drawings, FIGS. 1-6 illustrate an embodiment of ribbed extrusion depicted by panel 10. An extrusion of indefinite length is continuously produced as an elongated strip having a tongue 18, formed on one side of the strip and a mating groove 20 formed on the opposite side of the strip 16 receive adjacent panels, as shown in FIG. 6. Upon cooling the strip is severed, transversely into the panels 10, preferably of square configuration, about two feet square with a thickness of about 0.5 inch. Alternating ribs 14 and recesses 16 produced longitudinally in the strip during extrusion typically are about 0.5 inch wide and preferably are rounded.

A tongue 22 is formed at one longitudinal end and a mating groove 24 formed at the opposite longitudinal end during transverse severing of the strip into discrete panels.

The ribbed panel is placed rib-surface down during assembly of a plurality of panels on a substrate such as concrete floor. The sub-floor typically covers the whole of the concrete floor with underlying ribbed surface allowing any moisture such as water and damp air to circulate under the sub-floor through the recesses to a drain.

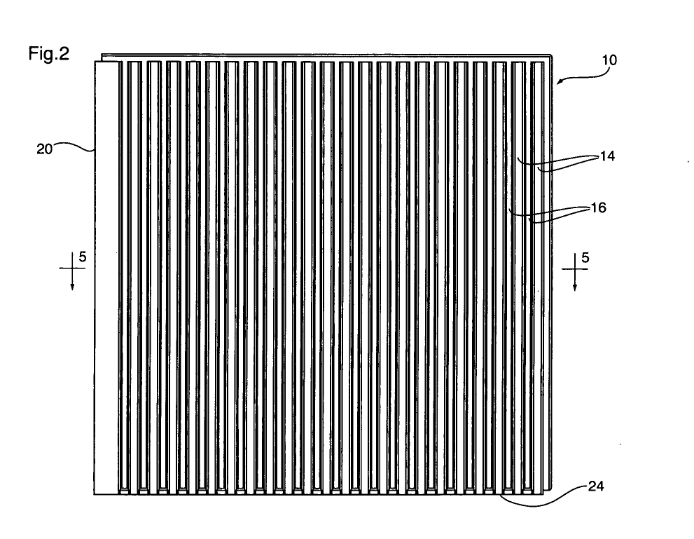

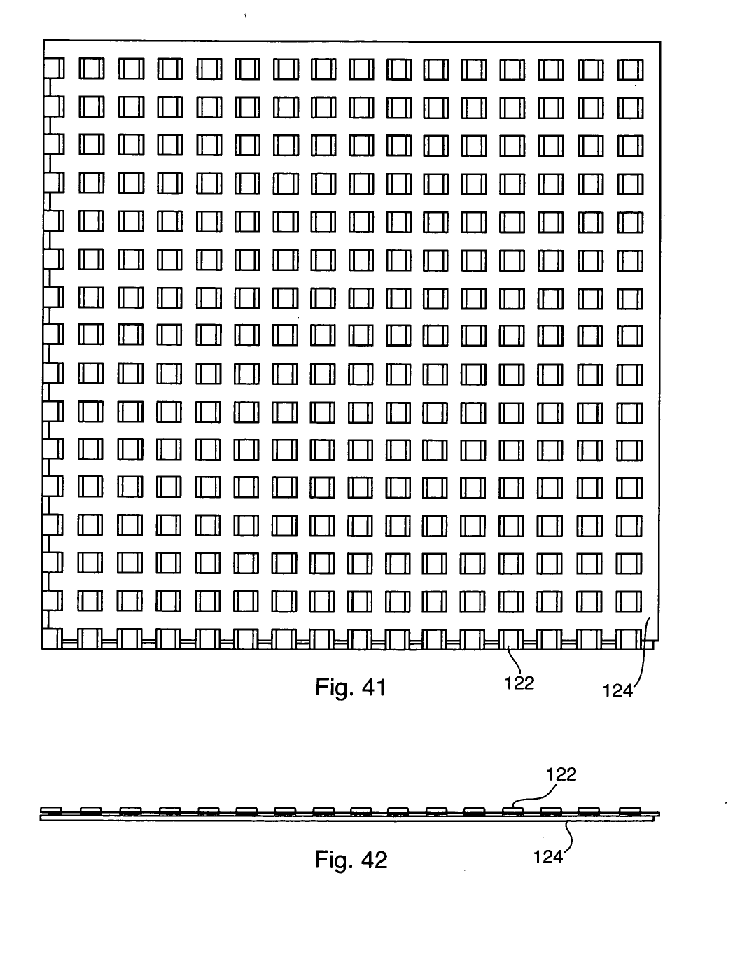

Equispaced transverse recesses 120 may be formed in the ribbed surface of the panel shown in FIG. 2 to form studs or knobs 122 depending from base 124 shown in FIGS. 41 and 42, preferably perpendicular to the ribs, to facilitate water drainage.

The product, if desired, may be sprayed with a coating of paint or polymeric resin.

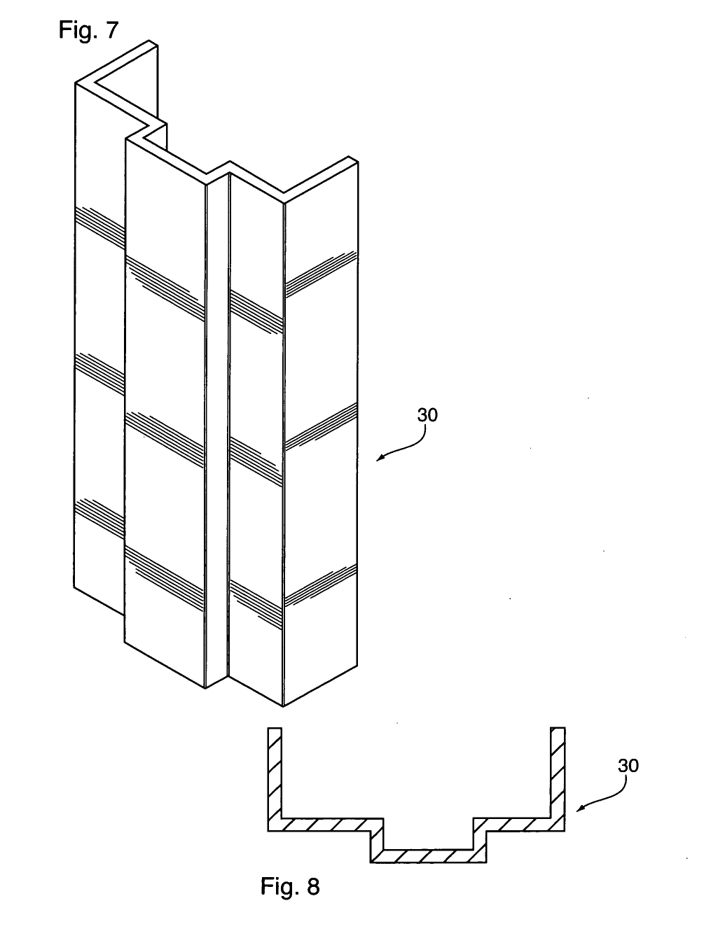

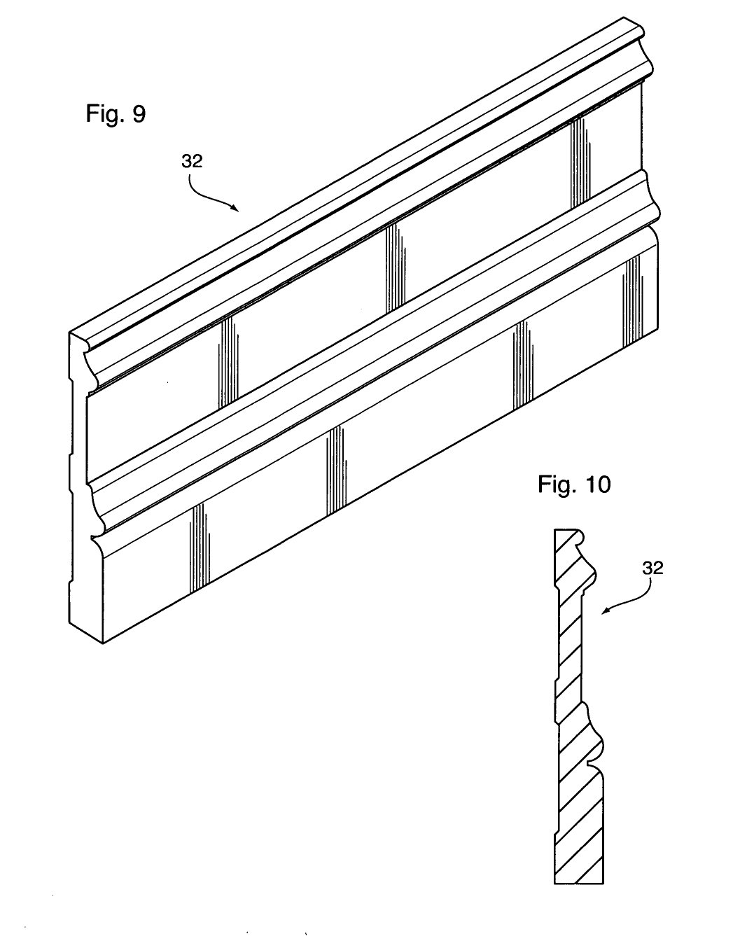

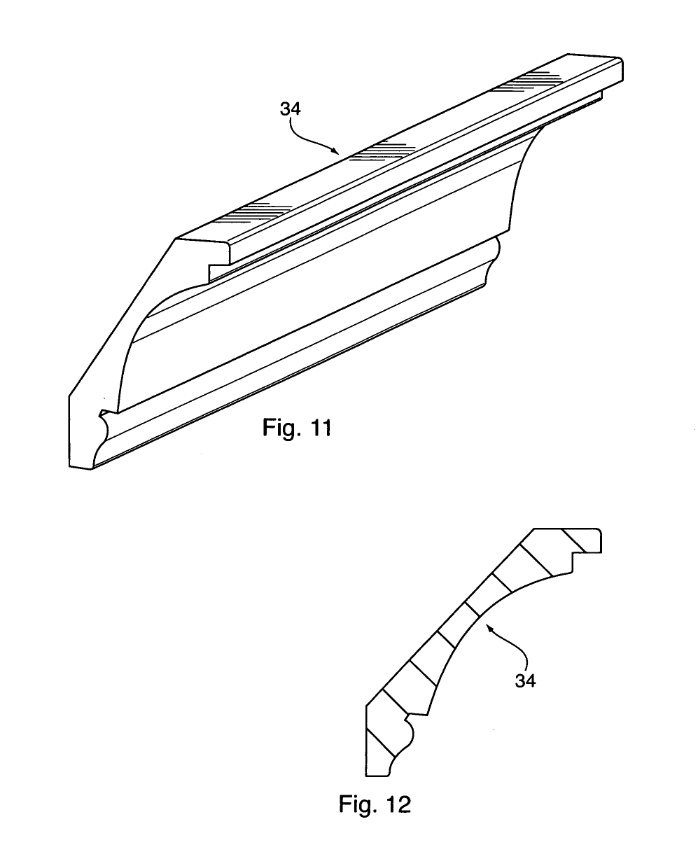

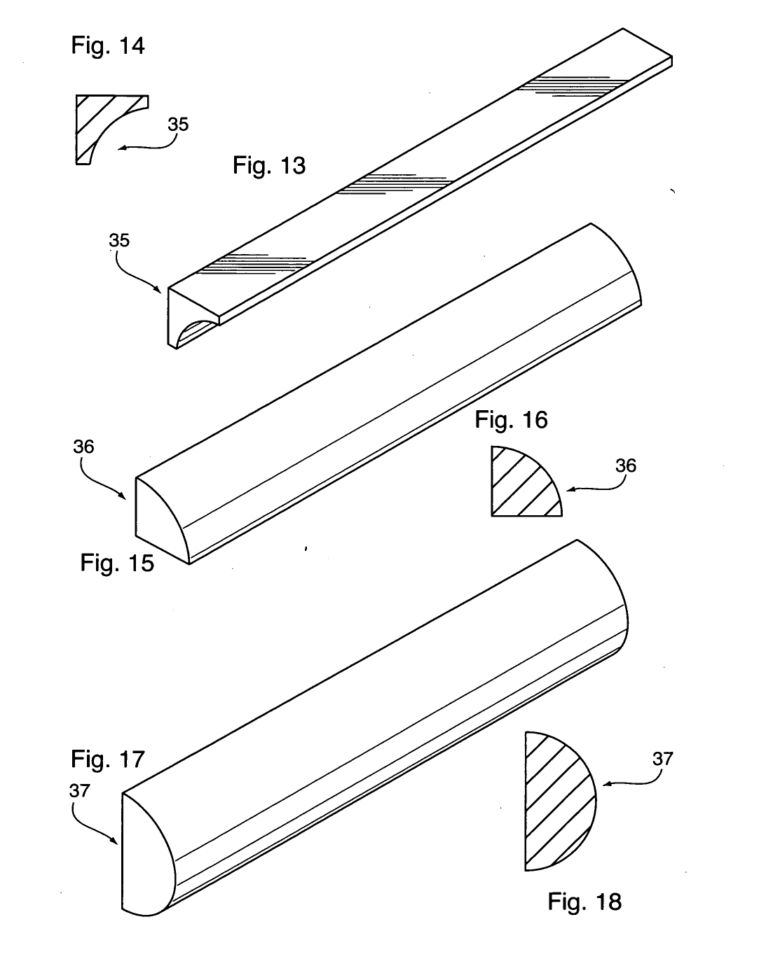

FIGS. 7-18 illustrate other shapes readily produced by the method and composition of the invention. FIGS. 7 and 8 show a door frame jamb and header 30, FIGS. 9 and 10 show a typical baseboard 32; FIGS. 11 and 12 show a cove molding 34, FIGS. 13 and 14 show a cove 35, FIGS. 15 and 16 show a quarter-round 36 and FIGS. 17 and 18 show a half-round 37.

The building products are well suited to working with carpenter tools and are amenable to assembly with nails and screws.

FIGS. 19-32 illustrate composite structures of the invention in which a glass fiber or graphite fiber reinforced plastic wire, rod, sheet or angle is combined with the composition of the invention for structural reinforcement of building products. The rod, wire or sheet reinforcement can be fed from a roll to the extruder die at the speed of extrusion for placement of the reinforcement in the extrusion profile in the portions of the profile which will experience tensile loads.

The plastic polymer preferably is unsaturated polyester but vinylester or epoxy resins may be used. The plastic resins are strong in compression whereas the glass and graphite fibers are strong in tension, imparting high tensile strength to the rod, wire and sheet and accordingly to the composite structure. Specific placements of the reinforcement in the building products in the portions of the structure that will experience tensile loads are shown in the drawings.

FIGS. 19 and 20 illustrate an I-beam structure 50 having reinforcing glass fiber or graphite fiber plastic rods 52 positioned and fully encapsulated by the composition of the invention in the flanges 54 and glass fiber or graphite fiber plastic sheets 56 positioned and fully encapsulated in the web 58. Although three rods 52 and two sheets 54 are shown, it will be understood that the relative size, number and placement of reinforcement rods and sheets can be selected according to the size of the I-beams and the tensile loadings anticipated.

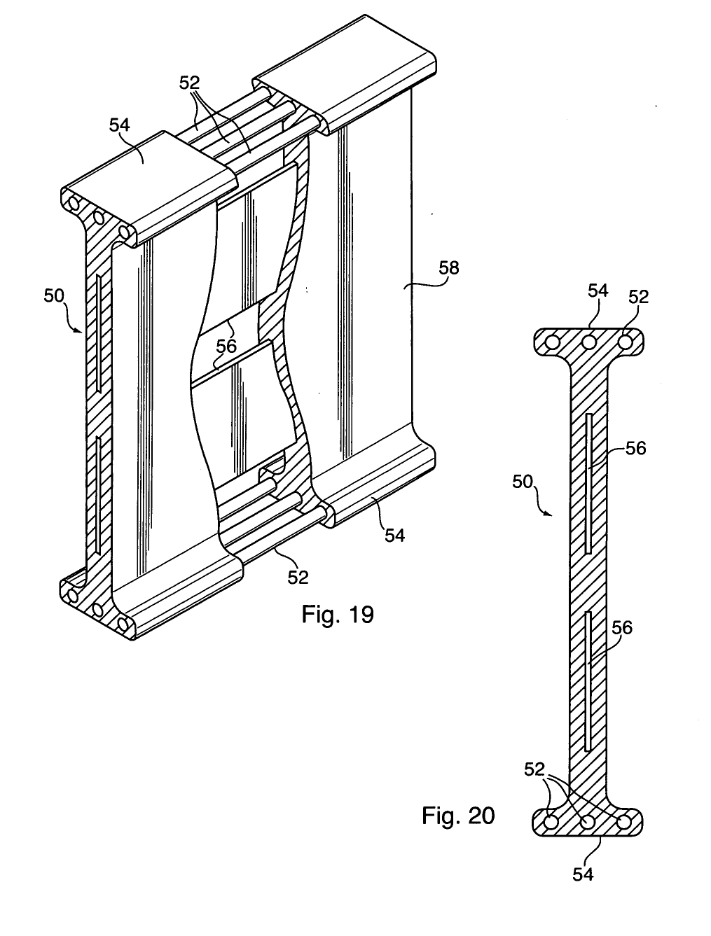

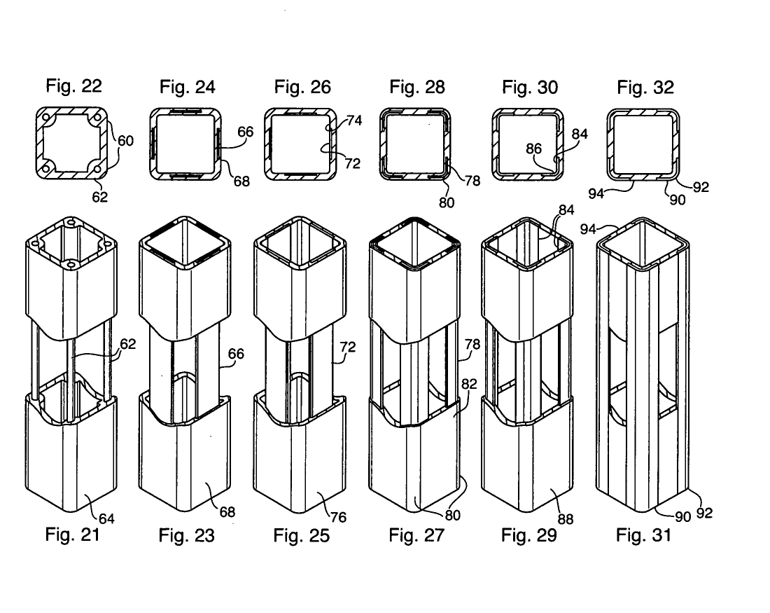

FIGS. 21 to 32 illustrate hollow box-like structures, suitable for use as posts or beams having a square, hollow cross-section. Although a square configuration is shown it will be understood that this shape is by way of illustration only and other rectangular cross-sections, or angle sections, are contemplated.

In FIGS. 21 and 22, reinforcing glass fiber reinforced plastic rods 60 are shown encapsulated in the corners 62 of the elongated hollow posts or'beams 64.

FIGS. 23 and 24 show glass fiber reinforced plastic sheets 66 encapsulated in the four side walls 68 of the elongated posts or beams 70.

FIGS. 25 and 26 show glass fiber reinforced plastic sheets 72 semi-encapsulated in the interior of the side walls 74 of posts or beams 76.

FIGS. 27 and 28 show glass fiber reinforced plastic angles 78 fully encapsulated in the corners 80 of posts or beams 82.

FIGS. 29 and 30 show glass fiber reinforced plastic angles 84 semi-encapsulated in the interior of corners 86 of posts or beams 88.

FIGS. 31 and 32 show glass fiber reinforced plastic angles 90 semi-encapsulated on the exterior of corners 92 of posts or beams 94.

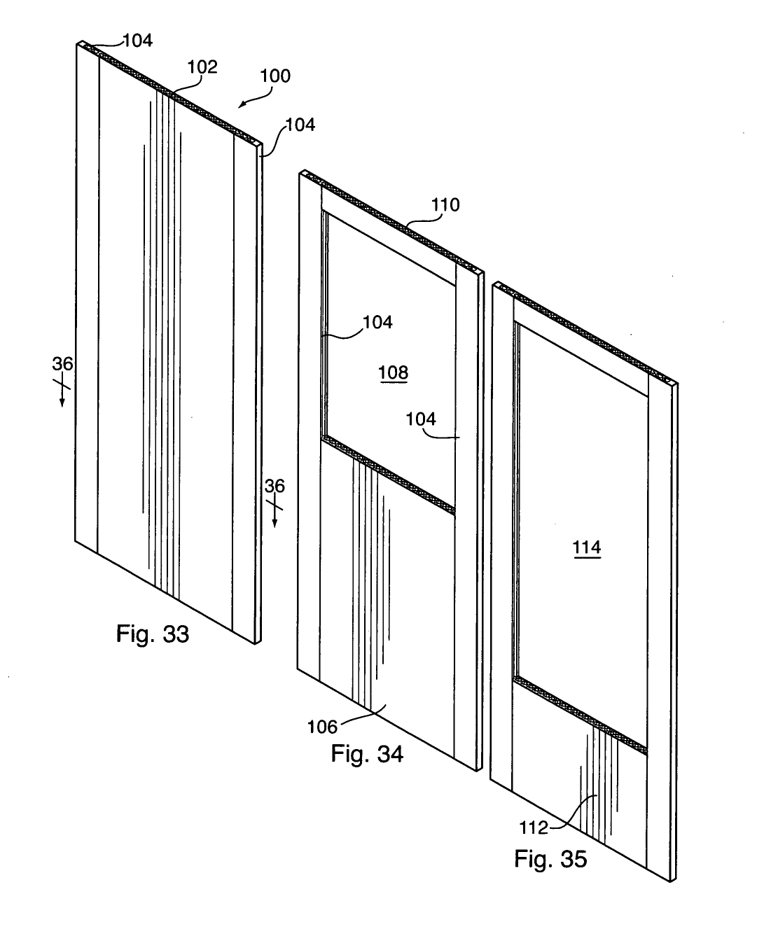

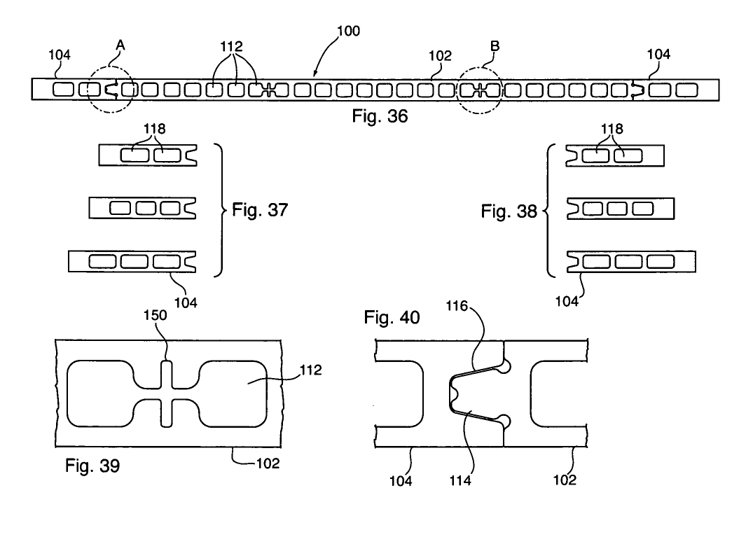

With reference now to FIGS. 33 to 40, panel, door and window constructions are illustrated. FIG. 33 shows a panel or door 100 comprising a central planar extrusion member 102 and elongated side extrusion members 104, shown in more detail in FIGS. 36 to 40. FIG. 34 shows door having a shortened central member 106 defining an opening 108 for a window between lintel 110 and side members 104.

FIG. 35 shows a further shortened central member 112 defining an enlarged opening 114 suitable for a storm door having a large window and a self-storing screen (not shown).

FIGS. 36 to 40 illustrate the cross-sections of central, planar extrusion member 102 and side extrusion member 104 in which planar member 102 has a plurality of equispaced longitudinal holes 112 to reduce weight. The opposite sides of planar member 100 have a longitudinal tongue 114 formed therein for mating with longitudinal groove 116 formed in side members 104, as shown more clearly in FIG. 40. Embodiments of side members 104 shown in more detail in FIGS. 37 and 38 preferably have two or more longitudinal equispaced holes 118 formed therein for weight reduction.

FIG. 39 illustrates longitudinal internal slots 150 for receiving screws, not shown.

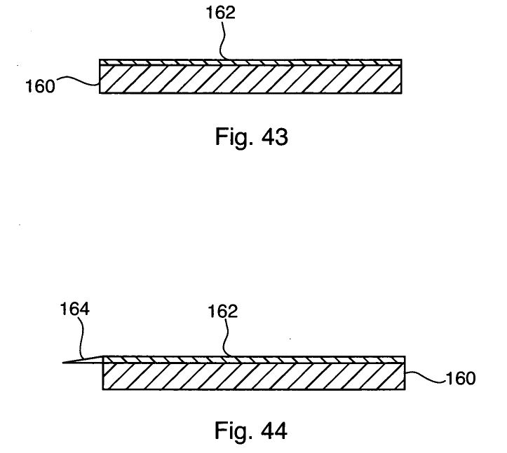

FIG. 43 shows an extruded slab or deck board 160 of the invention having a capping veneer 162 such as a vinyl sheet adhesively secured thereto by carpenter's glue or by a film-backed adhesive well known in the art. Veneer 162 alternatively can be a rigid thermoplastic polymer such as vinyl co-extruded with slab or board 160.

FIG. 44 shows an embodiment of cap stock comprising a soft and flexible tab or sealing flap 164, formed from a vinyl elastomer, co-extruded with board 160 and rigid vinyl sheet 162, to provide a flexible weather seal along an edge of board 160.

The composition of board 160 may include a (*Wing agent to provide an expanded closed-cell extrusion which is light in weight having capping veneer 162 co-extruded with or adhesively secured thereto.

The present invention provides a number of important advantages. Rice husks otherwise disposed as agricultural waste are ground to a fine size and extruded with particulate thermoplastic polymers such as polyolefin resins and other solid constituents to produce a continuous extrusion of desired profile, with for example tongue and groove side edges. The strip is suitable for simple transverse cutting and shaping to produce interlocking panels suitable for assembly as a continuous sub-floor. Waste material from the transverse cutting and shaping of the floor panels may be ground to a fine size and recycled, resulting in no waste material. The rice husks provide enhanced thermal insulation and a vapour seal to impede moisture transfer. The underlying ribbed or knobbed configuration provides optimum vertical support to an overlying finished floor while permitting moisture to circulate below the sub-floor to drainage. A variety of other building products can be produced which are suitable for shaping and assembly with conventional, wood-working tools.

Composite structural members such as posts, beams, angles and I-beams having glass or graphite reinforced plastic rods, wire, angles, or sheets partially or fully encapsulated by the composition of the invention have structural rigidity and dimensional stability.

Cap stock comprised of coextruded or glued vinyl or the like capping veneers bonded to solid or cellular core extrusions of the invention provide light-weight, weather and U-V resistant decking with special textures such as wood grain.

It will be understood that other embodiments and examples of the invention will be readily apparent to a person skilled in the art, the scope and purview of the invention being defined in the appended claims.

1. A thermal insulating and substantially moisture impermeable rigid extrusion comprising 40 to 75 wt % rice husks, 0.3 to 3 wt % coupling agent, 2 to 5 wt % lubricant, 1 to 5 wt % of a plasticizer, the balance a thermoplastic polymer, said rice husks having a particle size in the range of 20 to 80 U.S. Sieve size.

2. A rigid extrusion as claimed in claim 1, in which the rigid extrusion is an elongated strip.

3. A rigid extrusion as claimed in claim 2, in which the rigid extrusion is an elongated panel, a sheet, a board, a stud, a door frame jamb, a door frame header, a post, a beam, a casing, a baseboard, a quarter-round, a cove molding, a fascia, a soffit, a lintel, an angle or an I-beam.

4. A rigid extrusion as claimed in claim 3, in which the thermoplastic polymer has a particle size in the range of ⅜ inch to ½ inch and is a thermoplastic PVC, polyurethane, polyester or a polyolefin selected from the group consisting of high density polyethylene, low density polyethylene, linear low density polyethylene, homopolymer polypropylene, copolymer polypropylene, and combinations thereof.

5. A rigid extrusion as claimed in claim 4, comprising 60 to 70 wt % rice husks, 0.5 to 1.5 wt % coupling agent, 2 to 2.5 wt % lubricant, 2 to 3 wt % plasticizer, the balance thermoplastic polymer.

6. A rigid extrusion as claimed in claim 1, in which the rigid extrusion has a pair of longitudinal side edges and a plurality of longitudinal ribs and recesses formed across a face thereof substantially from one side edge to the other, a longitudinal tongue formed on one side edge and a longitudinal groove formed on the other side edge.

7. A rigid extrusion as claimed in claim 6, in which the rigid extrusion is rectangular in shape forming a floor panel having a pair of transverse ends, with a transverse tongue formed across the panel in one end and a mating groove formed across the other end for assembly of abutting panels together side-to-side and end-to-end to produce a continuous floor surface adapted for assembly with the ribbed surface facing downwardly.

8. A floor panel as claimed in claim 7, in which the floor panel is square.

9. A floor panel as claimed in claim 8, in which the thermoplastic polymer has a particle size in the range of ⅜ inch to ½ inch and is a polyolefin selected from the group consisting of high density polyethylene, low density polyethylene, linear low density polyethylene, homopolymer polypropylene, copolymer polypropylene, and combinations thereof.

10. A floor panel as claimed in claim 9, in which the floor panel comprises 60 to 70 wt % rice husks, 0.5 to 1.5 wt % coupling agent, 2 to 2.5 wt % lubricant, 2 to 3 wt % plasticizer, the balance a thermoplastic polyolefin plastic.

11. A floor panel as claimed in claim 10, in which the longitudinal ribs and recesses formed across a face of the panel are equispaced and have a spacing of from 0.5 to 0.8 inches.

12. A floor panel as claimed in claim 9, in which the floor panel has transverse ribs and recesses, formed across the lace perpendicular to the longitudinal ribs and recesses whereby knobs are formed.

13. A rigid extrusion as claimed in claim 1, which additionally comprises at least one elongated reinforcing wire, rod, sheet or angle partially or fully encapsulated within the extrusion.

14. The rigid extrusion as claimed in claim 13, in which the rigid extrusion is a hollow post or beam or is an I-beam having the at least one wire, rod or sheet encapsulated therein.

15. A rigid extrusion as claimed in claim 2, which additionally comprises a veneer adhesively secured to the rigid extrusion or co-extruded with the rigid extrusion.

16. A rigid extrusion as claimed in claim 14, in which the veneer is a vinyl sheet.

17. A rigid extrusion as claimed in claim 15, in which the rigid extrusion is cellular.

18. A rigid extrusion as claimed in claim 3, additionally comprising a soft vinyl extrusion co-extruded with the rigid extrusion to form a soft tab, protrusion or surface on an edge or side of the rigid extrusion.

19. A method of producing a thermal insulating and moisture impermeable rigid extrusion comprising mixing 40 to 75 wt % rice husks, 0.3 to 3 wt % coupling agent, 2 to 5 wt % lubricant, 1 to 5 wt % plasticizer, the balance a particulate thermoplastic polymer plastic, and extruding the mixture at a temperature in the range of about 300° to 400° F. through a die having a profile for producing a strip of indefinite length.

20. A method as claimed in claim 19, in which the mixture comprises 60 to 70 wt % rice husks, 0.5 to 1.5 wt % coupling agent, 2 to 2.5 wt % lubricant, 2 to 3 wt % plasticizer, the balance the thermoplastic polymer.

21. A method as claimed in claim 20, in which the thermoplastic plastic IS a thermoplastic PVC, polyurethane, polyester or polyolefin selected froth the group consisting of high density polyethylene, low density polyethylene, linear low density polyethylene, homopolymer polypropylene, copolymer polypropylene, and combinations thereof.

22. A method of producing a thermal insulating and moisture impermeable floor panel comprising mixing 40 to 75 wt % rice husks; 0.3 to 3 wt % coupling agent, 2 to 5 wt % lubricant, 1 to 5 wt % plasticizer, the balance a particulate thermoplastic polyolefin plastic, extruding the mixture at a temperature in the range of about 300° to 400° F. through a die having a profile for producing a strip of indefinite length, having a pair of opposite longitudinal side edges, one of said side edges having a tongue and the other side edge having a mating groove and said strip having a planar surface on one side and a longitudinal ribbed surface on the other side, cooling said strip and transversely cutting and shaping said strip to produce a rectangular panel having opposite transverse ends with a tongue limited across one end and a mating groove formed across the opposite end.

23. A method as claimed in claim 22, in which the mixture comprises of 60 to 70 wt % rice husks, 0.5 to 1.5 wt % coupling agent, 2 to 2.5 wt % lubricant, 2 to 3 wt % plasticizer, the balance a thermoplastic polyolefin plastic.

24. A method as claimed in claim 22, in which the thermoplastic polymer is a polyolefin plastic selected from the group consisting of high density polyethylene, low density polyethylene, linear low density polyethylene, homopolymer polypropylene, copolymer polypropylene, and combinations thereof.

25. A method as claimed in claim 24, additionally comprising forming equispaced transverse recesses in the ribbed surface to form a knobbed surface.

26. A method as claimed in claim 19, in which the strip is a sheet, a board, a stud, a door frame jamb, a door frame header, a post, a beam, a casing, a baseboard, a quarter-round, a cove molding, a fascia, a soffit, a lintel, an angle or an I-beam.

27. A method as claimed in claim 19, which additionally comprises feeding at least one reinforcing wire, rod, sheet or angle through the die while extruding the mixture for partially or fully encapsulating the reinforcing by the thermoplastic polymer.

28. A method as claimed in claim 27, in which the extrusion is an I-beam or hollow post or beam.

29. A method as claimed in claim 19, additionally comprising co-extruding or adhesively securing a rigid veneer onto the extrusion.

30. A method as claimed in claim 19, additionally comprising co-extruding a soft vinyl polymer onto a surface or an edge of the extrusion.

31. A method as claimed in claim 29, additionally comprising co-extruding a soft vinyl polymer onto a surface or an edge of the extrusion.
